(19) United States
(12) Patent Application Publication
(10) Pub. No.: US 2023/0380423 A1
(43) Pub. Date: Nov. 30, 2023

(54) SANITARY PROCEDURES AND PRODUCTS

(71) Applicant: BALLOONX SÁ.R.L, Luxembourg (LU)

(72) Inventors: Harm KIEZEBRINK, Torekov (SE); Nicole KREFTING, Uddevalla (SE)

(21) Appl. No.: 18/034,159

(22) PCT Filed: Nov. 25, 2021
(86) PCT No.: PCT/EP2021/082988

§ 371 Date: Apr. 27, 2023

(30) Foreign Application Priority Data
Nov. 25, 2020 (SE) 2051372-7

(51) Int. Cl. A01N 59/00; A01N 25/16; A01P 1/00; A22B 5/00

(52) U.S. Cl. CPC A01N 59/00; A01N 25/16; A01P 1/00; A22B 5/0082; A22B 3/00

(57) ABSTRACT

Methods of performing sanitary procedures in a defined space are disclosed that comprise; introducing to said space a foam comprising a foaming agent and a gas; adjunctively to introducing the foam, introducing to said space a composition comprising an effective amount of chlorine dioxide; and admitting the foam to sufficiently fill said space, thereby admitting the chlorine dioxide composition to sufficiently sanitize the space and surfaces of subjects and/or objects present therein. Sanitizer and/or disinfectant products are also disclosed, comprising a foaming agent and an aqueous disinfectant and/or sanitizing composition comprising chlorine dioxide and an effect supporting surfactant system.

### TECHNICAL FIELD

The present invention generally relates to methods of products to sanitize selected environments with a high expansion foam and a disinfection and/or sanitizing agent comprising chlorine dioxide.

### BACKGROUND OF THE INVENTION

In the area of industrial agriculture sanitary killing of animals subjected to animal husbandry (e.g., stunning for disease control), it can be necessary in the context of outbreaks of pathogenic diseases to effectively minimize damages and health risks. It is a considerable technical problem to perform such operations with consideration to animal welfare and yet maintain industrial efficacy and safety.

For this purpose, WO2018/106115 describes methods of stunning or killing animals confined in a container introducing a foam, comprising a gas such as nitrogen to expel essentially all air in the container. EP 3473104 describes methods of providing such gas-based stunning of animals that introduce a technology to optimize the fraction of relatively large bubbles in the foam to avoid that animals enter a prolonged stage of asphyxiation at risk from an excess of small bubbles in the foam.

WO 2007/021178 describes a method for sanitary slaughter of animals, comprising covering the animal with a foam produced from a liquid containing a surfactant, a disinfecting component and a killing and/or narcotizing gas. The foam containing liquid can further comprise a disinfectant such as an active chlorine compound selected from chlorine (Cl₂) or hypochlorite (OCl⁻).

U.S. Pat. No. 4,889,654 discloses surface disinfection with a foam with chlorine dioxide gas entrained therein. This technology will not satisfy demands to sanitize spaces and will not be useful as an adjunct method in agricultural disease control.

WO 2007//129100 discloses methods of killing animals by combining a foam with stunning gas from balloons. Simultaneous disinfection is mentioned without any further guidance.

It remains a problem to effectively combine the methods of using high expansion foam as in the operations described, while adjunctively performing an effective disinfection from pathogens. It is a necessary requirement to prevent that the disinfectant negatively impact foam quality and that the foam and the disinfectant can operate without negatively impacting each other. In this context, it is desirable to find a disinfectant that that is highly effective to kill pathogens in the context of performing sanitary slaughter of animal with an established foam technology.

### DESCRIPTION OF THE INVENTION

It is an object of the invention to combine a high expansion foam procedure with an effective disinfection procedure that does not interfere with the performance of the foam.

It is object of the invention to provide a sanitary procedure for pathogen infected animals subjected to animal husbandry that exerts an effective elimination of pathogens in a set time frame of performing a stunning procedure with a foam technology and thereby employ comparatively low levels active agent of a sanitizing agent.

It is an object of the invention to obtain an effective disinfection procedure that effectively admits elimination of pathogens, especially virus, at low levels of active agents and that is supported in efficacy by a high expansion foam procedure.

It is an object of the invention to provide sanitary agricultural procedure that supports a disinfectant and/or sanitizing agent to correctly become distributed to all surfaces in a space assigned for animals subjected to animal husbandry and to correctly reach circulating dust particles, materials and equipment in the space.

In a general aspect, the present invention is directed to a method of performing a sanitary procedure in a defined space. The method generally comprises that a foam comprising a foaming agent and a gas is introduced to the space; that a composition comprising an effective amount of chlorine dioxide is introduced adjunctively to the foam; and that the foam is admitted to sufficiently fill the space, so the chlorine dioxide composition is admitted to sufficiently sanitize or disinfect the space and surfaces of subjects and/or objects present therein.

In this and other general contexts of the invention, the term “adjunctively introducing” has a wide meaning including that the foam and the disinfectant composition are introduced simultaneously or at separate time points when performing the method. It can mean that the foaming agent and the disinfectant composition are present in the same liquid subjected to a foam generator and thereby introduced together in the foam. It can mean that the disinfectant is introduced separately from the foam generator and mixed or distributed with the foam.

The term “space” normally means a closed space that may essentially be filled with foam according to the methods. The term “a defined space assigned for animals subjected to animal husbandry” is a space where domesticated animal species are raised or resides for commercial or subsistence purposes. The term “space” can also mean a closed container assigned to perform the methods of the invention.

The terms “disinfectant” or “disinfecting agent” as used has the meaning of neutralizing or eliminating microorganisms including, but not limited to bacteria and spores, virus particularly on surfaces.

The term “aspect agent” or “asepticizer” as used herein is an agent reduces or eliminates microorganisms on a living tissue, i.e., the skin, a wound, a fur or on feathers in agricultural applications.

The term “sanitizer” or “sanitizing agent” as used herein shall be regarded as broader term covering all aspects of eliminating or reducing levels of microorganisms.

In important embodiments, the foam is a high expansion foam. A high expansion foam preferably has an expansion factor of at least 350, more preferably at least 500, most preferably at least 750, wherein the expansion factor is the resulting foam volume divided with volume of the liquid foaming agent. In this context, it is preferred that foam comprises a suitably high fraction of large bubbles of a diameter of at least 5 mm. Preferably, the high expansion foam is water based. It is also preferred that the foam can form a plug flow so it may readily and cohesively be expelled from the space, for example in applications depending on several, separately or sequentially introduced foams to the space. Examples of suitable foams are provided in the following sections.

The method generally includes the use of a foam generator. Suitable foam generators are known to person skilled in the art from e.g., EP3473104, wherein means to control the bubble size of the foam are disclosed. However, other technologies can be used, such as fans used for firefighting.

In one preferred embodiment of the method, the disinfectant and/or sanitizing composition is an aqueous acidic solution comprising 100 to 2000 ppm chlorine dioxide and a disinfection and/or sanitizing effect supporting surfactant system. Preferably, the solution has a pH of 1 to 5.5.

In certain embodiments, the methods are performed in spaces assigned for animals subjected to animal husbandry residing in such a space.

In embodiments, the methods useful in animal husbandry comprise introducing a first foam with a gas comprising a muscle relaxant without inducing unconsciousness of the animals in the space. Preferably, the gas comprises air or a sufficient level of oxygen to avoid unconsciousness of the animals The methods can further comprise introducing a second foam and thereby expelling the first foam. The second foam is adjunctively introduced with a disinfection agent, as previously defined, to generate a disinfectant foam. In one alterative the second foam comprises air so method results in reducing or eliminating microorganism on living tissues. In other alternatives, the second foam comprises a stunning gas with least 95% nitrogen and less than 2% of carbon dioxide and/or oxygen, preferably at least 98% nitrogen and more preferably 100% nitrogen. With the method the second foam can be arranged to expel the first foam which can be collected and processed to extract dissolved muscle relaxant for suitable processing for reuse. The muscle relaxant is preferable a gaseous muscle relaxant selected from at least one of NO, N₂O and diethyl ether. In many applications, N₂O is preferred.

In embodiments, the invention relates to a method of performing a sanitary agricultural procedure on animals subjected to animal husbandry infected, or possibly infected, by one or more pathogens and residing in a closed space. The method comprises introducing a foam to the closed space, such a container, comprising a foaming agent and a gas capable of stunning the animals; and adjunctively to introducing the foam, introducing a disinfectant composition to the closed space, comprising chlorine dioxide. The foam is admitted to stun the animals and to support that the disinfectant admits effective elimination of pathogens. WO 2018/106115 further discloses useful ways for the inventive methods to operate the foam to expel air from the closed space and to use stunning gases. Preferably, the gas of the foam comprises of at least 95% nitrogen and less than 2% of carbon dioxide and/or oxygen, preferably at least 98% nitrogen and more preferably 100% nitrogen. In alternatives, a first foam with a gas with such stunning capacity is administered and a second foam is introduced adjunctively with the disinfectant composition, comprising chlorine dioxide. The second foam can thereby be arranged to expel the first foam from the closed space or be introduced following that the first foam is broken up and its efficacy is examined. In such applications it is preferred to introduce the second foam below the first foam, for example in a container as outlined in WO 2018/106115.

In one embodiment, the invention relates to a method of performing a pest control procedure of a space assigned for animals subjected to animal husbandry, or a space for shipping and storage food products, or other spaces assumed to be inhabited by unwanted populations of insects and/or rodents. The method comprises introducing a foam to the space, comprising a foaming agent and a stunning gas; and adjunctively to introducing to the space the foam and a disinfectant composition, comprising chlorine dioxide. The foam is admitted supporting that the disinfectant admits effective elimination of potential pathogens. Preferably, the gas of the foam has stunning capacity and preferable comprises of at least 95% nitrogen and less than 2% of carbon dioxide and/or oxygen, preferably at least 98% nitrogen and more preferably 100% nitrogen.

In embodiments of the method, it is directed to sanitize a selected space without any residing animals, for example barns and stables. In such embodiments, the method comprises introducing to the space a foam comprising a foaming agent and a gas that preferably is air is introduced; adjunctively introducing a composition comprising an effective amount of chlorine dioxide; and admitting the foam to sufficiently fill the space, so the chlorine dioxide composition is admitted to sufficiently sanitize or disinfect the space and surfaces of subjects and/or objects present therein.

In these general contexts, the term “pathogen” means highly contagious microorganisms capable of affecting large populations of animals at risk to spread in the society as an epidemic including but not limited to virus, including respiratory virus, such as types of influenza virus and coronavirus, rhinovirus and calicivirus; to bacteria and spores thereof, such as Mycobacterium tuberculosis, Bordetella pertussis, fungi such as aspergillus.

In embodiments, the inventive methods are used to eliminate odors and associated microorganisms from defined spaces that comprises that a foam comprising a foaming agent and a gas is introduced to the space; introducing adjunctively to the foam, a composition comprising an effective amount of chlorine dioxide; and that the foam is admitted to sufficiently fill said space or a designated part or area of such a space, so the chlorine dioxide sufficiently can sanitize the space and surfaces, or objects present therein. Preferably, the foam comprises a foaming agent and air. In applications, the foam can be arranged as a cover of particularly contaminated areas in order to form a temporary isolation. Such embodiments of odor elimination are applicable in a wide field of agriculture and food production or transportation and may in certain applications be combined with other methods described herein.

In embodiments, the method can be performed as a sanitary procedure to eliminate pathogens in stunned animals or animals slaughtered with other procedures to sanitize animal bodies in order to safely recover animal products, such as hides and fur. Such a method is performed in a defined space accommodating the animals that comprises that a foam comprising a foaming agent and a gas is introduced to the space; that a composition comprising an effective amount of chlorine dioxide is introduced adjunctively to the foam; and that the foam is admitted to sufficiently fill said space, so the chlorine dioxide composition is admitted to sufficiently sanitize the space and the animals present therein.

In embodiments of the method, it comprises simultaneously introducing the foam and the disinfectant composition to a confined space. In one aspect the liquid comprising foaming agent and disinfectant composition can be present in the same aqueous solution, either by storage or by that they are combined before being supplied to the foam generator. In another aspect, the liquid comprising foaming agent and disinfection agent are separately introduced to the confined space where the method is performed.

With the methods of the present invention the contact time for the foam will vary with the applications and the necessity to conform with established industry processes. For applications including foam based stunning of animals and adjunct disinfection or sanitation it is preferred to essentially conform with the duration of foam stunning methods applied in agriculture. For this reason, the contact time are preferably less than 30 minutes, such less than 20 minutes, less than 15 minutes, less than 10 minutes, preferably 1 to 10 minutes, such as 5 to 10 minutes. In applications as previously outlined for pest control, elimination of odor or sanitation empty spaces, such as brans or stables, it is desirable with longer contact times that extend for several days, as exemplified with contact times between 30 minutes to 48 hours, 1 hour to 48 hours, 1 hour to 24 hours.

In another general aspect, the present invention relates to a product that is useful to perform any of the previously described methods. The following defined products can be used with any of the so far described methods.

In a first general embodiment, the invention relates to a product for sanitizing an agricultural production area, comprising a foaming agent and an aqueous disinfectant composition comprising chlorine dioxide and an effect supporting surfactant system. In this general context, an effect supporting surfactant system is capable of assisting the chlorine dioxide to attack the pathogenic microorganisms by solubilizing and/or wetting effects necessary to access all surfaces and dust particles in the confined space for correct elimination of pathogens also adhering to surfaces, for example in spore form.

In embodiments of the product, the foaming agent is an aqueous solution comprising compounds selected from one or more of the group of a glycol ether solvent; one or more ethoxylated sodium alkyl ether sulfates; and one or more fatty alcohols with saturated carbon chains. In embodiments the foaming agent is an aqueous solution comprising at one or more of 2-(2-butoxyethoxy)ethanol; sodium salts of sulfated, ethoxylated C12-C14 alcohols, sodium alkyl sulfates and tetradecanol. In embodiments, the foaming agent comprises effective amounts of 2-(2-butoxyethoxy)ethanol, two different sodium alkyl ether sulfates with different levels of ethoxylation, dodecanol and tetradecanol. Suitable such agents are Agrifoam C5 from SABO FOAM s.r.L and HTF-100 from Dr. Sthamer, Hamburg.

In embodiments of the product, the disinfectant composition has a pH of 1 to 5.5, preferably 1.5 to 4, comprises 50 to 2000 ppm chlorine dioxide and the supporting surfactant system comprises at least one cationic surfactant.

In embodiments of the product, the disinfectant composition has a supporting surfactant system comprising two or more amine oxides, preferably with different carbon chain lengths, more preferably the amine oxide comprises one amine oxides with 8 carbon atoms (C8) and one amine oxide with 12 carbon atoms (C12).

In embodiments of the product the foaming agent and the disinfectant composition are formulated as separately stored aqueous solutions as parts of a kit.

In embodiments of the product, the foaming agent and the disinfectant composition are formulated together in an aqueous solution. In one example, the product comprises 1 to 10% (volume) of the foaming agent; from 1 to 50% (volume) aqueous disinfectant and/or sanitizing composition and the remaining part water. The product concentration of chlorine dioxide varies dependent on the concentration in the disinfectant agent. In some embodiments the product during storage or following combination from a kit holds 400 to 1000 ppm of chlorine dioxide. Depending on the application the amount of aqueous disinfectant can vary to 1 to 30, 1 to 20 or 1 to 10% (v/v) in such a foamable product solution. The amount foaming agent can also be selected to conform with applications where more durable foam is required for extended contact periods for necessary sanitation and high levels of foaming agent.

The invention as described is applicable in standard emergency response procedures relevant to urgent outbreaks of high pathogen animal diseases for the purpose to neutralize the pathogens and to reduce the risks of spreading of infectious diseases to locations outside the immediate premises of an outbreak. This application thereby admits protecting human health; on protecting animal welfare, reducing the number of responders (and the involved costs); and contributes to minimizing the impact for the industry at large by creating permanent and sustainable solutions.

### Detailed and Exemplifying Description

In the following examples of the invention HTF-100 from Dr. Sthamer, Hamburg is selected as a foaming agent capable of forming a high expansion foam and LifeClean® from LifeClean International AB is selected as a disinfectant/sanitizer composition.

### Example 1

In order to prevent sows and growing pigs with a weight of up to 30 kg to get infected, the barn needs to be sanitized before restocking in the barn.

The first step of the procedure is to sanitize all surfaces in the barn, were possible infectious microbes could have been contaminating organic materials in dust and dust particles, on surfaces such as floors, walls, ceiling, equipment, materials. The High expansion foam in order to distribute the disinfectant/sanitizer equally throughout the entire barn.

High expansion foam with a gas like nitrogen or carbon dioxide is used, ensuring an oxygen level of <1% by volume in case the barn is habituated with insects and rodents that could transfer contaminated materials to locations outside the barn. The high expansion foam filled with nitrogen effectively kills all insects and rodents within minutes after they are captured inside the high expansion foam.

After the foaming procedure, the barn, including all materials are rinsed, following a standard operating procedure that removes all contaminated materials on the surface of the building, all equipment inside the barn, followed by a disinfection/misting procedure, in order to ensure that all materials are cleaned and disinfected before the barn is restocked with piglets.

The procedure to create the high expansion foam is based on the mix of water (90% to 96% by volume), high expansion foam detergent (3% by volume), and the disinfectant/antiseptic agent (1% to 10% by volume). The composition of the fluid is than mixed with air or gas, creating high expansion foam. The high expansion foam is than distributed throughout the entire barn, until all surfaces effectively have been reached.

5 to 10 minutes after the barn is completely filled with foam, the foam can be destructed following a rinsing procedure with pressurized air or misting with alcohol or flushing with water. A complete sanitizing procedure contains different steps, including: a foaming procedure with high expansion foam that includes both a disinfection/antiseptic procedure eliminating microorganisms and a pest control procedure eliminating insects and rodents and a rinsing procedure with water and detergent; and to fulfil any standard operational procedures optionally a complementing disinfection process including misting performed with LifeClean®.

### Example 2

In case there is a serious suspicion or confirmation that the farm is infected, the first step is to place the small piglets in a small compartment like a container that can be closed and sealed off. As soon as the animals are placed inside the compartment, the foaming procedure as described in Example 1 is used, combining the fluid mix and a high concentration of gas, preferably nitrogen. The piglets are stunned, killed sanitized within the same procedure. The possible reproduction of viruses is stopped as soon as the piglets are killed, and the contagious microbes on the skin, on hair, nasal area as well as within the crotch area of the piglets.

The second step is to place foam generators next to the area where the sows are located in the barn. These foam generators produce high expansion foam filled with a high concentration of gas like nitrogen or carbon dioxide, preferable nitrogen. The barn is than filled with air filled high expansion foam, using the fluid mixture with the composition of high expansion foam agent and the disinfectant/sanitizer. When the barn is completely filed with this gas-filled foam, a second layer of high expansion foam with the fluid mixture containing the high concentration of nitrogen or carbon dioxide and fluid mixture with the composition of high expansion foam agent and the disinfectant/sanitizer.

At the moment the gas-filled high expansion foam rises and reaches the nasal area, the foam bubbles burst and the sows start to inhale the high concentration of gas. The inhalation of the high level of gas causes the sows to lose their posture, render unconscious and die. As soon as all convulsions has stopped, all the sows inside the foam are killed, the foam production of the high expansion foam is terminated. The layer of foam remains in place to prevent spreading of the infection as well as protecting the carcasses to get in contact with insects or rodents. The carcasses remain in the foam until they are collected and transported to the carcass disposal location.

### Example 3

A quantitative carrier test for automated airborne room disinfection was performed with methods according to the invention. Test methods were performed according to Swedish Standard SS-EN 17272:2020 applied on Staphylococcus aureus, see https://www.sis.se/produkter/halso-och-sjukvard/steriliserinq/desinficeringsmedel-och-antiseptika/ss-en-172722020/

Two different tests were performed with foamable solutions having different levels of chlorine dioxide and 5% (v/v) of the foaming agent Agrifoam C5. For Test 1 50% LifeClean 800 ppm was mixed with 50% water so the foamable solution comprises 400 ppm chlorine dioxide. For Test 2 33% LifeClean 1800 ppm was mixed with 66% water so the foamable solution comprise 600 ppm chlorine dioxide. For both Tests 1 and 2 foaming was added in amount so the foamable solutions have 5% (v/v) of foam agent.

For performing the tests, the system HEFT H1 was used as described in EP3483104B1 for foam production with a system volume 0.5 cubic meters. As test material Staphylococcus aureus ATCC 6538 were used in high level “dirty conditions” (10 g/I bovine albumin solution, 10 g/I yeast extract). As a reference a neutralizing solution was used comprising saponin 30 g/I; lecithin 3 g/I, histidine 1 g/I and polysorbate 30 g/I. Two stands with trays prepared with “dirty conditions” were put in the middle of system. The system was filled with foams according to Test 1 or Test 2 in 30 seconds, whereupon the system was left. After 5 minutes a first stand was removed and after 10 minutes the second stand was removed. The test materials from the trays were collected, removed for cultivation according to the Standard.

The results are demonstrated below in Tables 1-3 with the following designation terms:

N: is the number of colony forming units (CFU) per mL in test solution′
T: is the number of CFU per non-disinfected test surface.
n1: is the validation with neutralizing solution (non-toxic): casting
n2: is the validation with neutralizing solution (non-toxic): filtering
n3: is the validation with neutralizing solution (non-toxic): casting plate
n′1: is the number of CFU on filters and casted plate per 100 ml following disinfection.
n′2: is the number of CFU on a test surface following disinfection
N1: validation of N: casting
N2: validation of N: filtering
R: Reduction log(T)-log(treated plate)
I-III: test surfaces 1-3
The tests were performed at “high level” dirty conditions at contact times of 5 or 10 minutes. According to the standards a log reduction of at least 5 is considered acceptable.

### Example 3.1

Results from Test 1 with 400 ppm and a contact time of 10 min is demonstrated in Table 1A. Table 1 B demonstrates the validation.

TABLE 1A

| | | | | |
|---|---|---|---|---|
| Marking test | N | T | n′1 + n′2 | Log |
| surface | (CFU/mL) | (CFU/surface) | (Σ CFU/surface) | reduction |

EFFICIENCY TEST

| | | | | |
|---|---|---|---|---|
| I | 9.1 × 10⁸ | 2.9 × 10⁷ | 705 | 4.6 |
| II | 9.1 × 10⁸ | 2.9 × 10⁷ | 180 | 5.2 |
| III | 9.1 × 10⁸ | 2.9 × 10⁷ | 108 | 5.4 |

| | |
|---|---|
| Mean Log-reduction | 5.1 |

TABLE 1B
Test validation

| n1/N1 | n2/N2 | n3/N1 |
|---|---|---|
| n1: 1.1 × 10⁹ CFU/mL | n2: >1.0 × 10⁹ CFU/mL | n3: 9.8 × 10⁸ CFU/mL |
| Requirement | Requirement | Requirement |
| n1 > 0.5 N1 | n2 > 0.5 N2 | n3 > 0.5 N1 |
| 0.5N1 = 5.0 × 10⁸ CFU/mL | 0.5 N2 = 4.7 × 10⁸ CFU/mL | 0.5N3 = 5.0 × 10⁸ CFU/mL |
| Approved | Approved | Approved |

From the Tables 1A and 1B it is evident that a foam process according to the invention delivering 400 ppm Chlorine dioxide accomplishes mean log reduction of >5.

### Example 3.2

Results from Test 2 with 600 ppm and a contact time of 5 min is demonstrated in Table 1A. Table 1 B demonstrates the validation.

TABLE 2A

| | | | | |
|---|---|---|---|---|
| Marking test | N | T | n′1 + n′2 | Log |
| surface | (CFU/mL) | (CFU/surface) | (Σ CFU/surface) | reduction |

EFFICIENCY TEST

| | | | | |
|---|---|---|---|---|
| I | 9.1 × 10⁸ | 2.9 × 10⁷ | 2610 | 4.0 |
| II | 9.1 × 10⁸ | 2.9 × 10⁷ | 8.1 | 6.6 |
| III | 9.1 × 10⁸ | 2.9 × 10⁷ | 5.6 | 6.7 |

| | |
|---|---|
| Mean Log-reduction | 5.8 |

TABLE 2B
Test validation

| n1/N1 | n2/N2 | n3/N1 |
|---|---|---|
| n1: 9.5 × 10⁸ CFU/mL | n2: 9.9 × 10⁸ CFU/mL | n3: 1.1 × 10⁹ CFU/mL |
| Requirement | Requirement | Requirement |
| n1 > 0.5 N1 | n2 > 0.5 N2 | n3 > 0.5 N1 |
| 0.5N1 = 5.0 × 10⁸ CFU/mL | 0.5 N2 = 4.7 × 10⁸ CFU/mL | 0.5N3 = 5.0 × 10⁸ CFU/mL |
| Approved | Approved | Approved |

From the Tables 2A and 2B it is evident that a foam process according to the invention delivering 600 ppm Chlorine dioxide accomplishes mean log reduction of >5 with 5 minutes contact time.

### Example 3.3

Results from Test 2 with 600 ppm and a contact time of 10 min is demonstrated in Table 1A. Table 1B demonstrates the validation.

TABLE 3A

| | | | | |
|---|---|---|---|---|
| Marking test | N | T | n′1 + n′2 | Log |
| surface | (CFU/mL) | (CFU/surface) | (Σ CFU/surface) | reduction |

EFFICIENCY TEST

| | | | | |
|---|---|---|---|---|
| I | 9.1 × 10⁸ | 2.9 × 10⁷ | 1.2 | 7.4 |
| II | 9.1 × 10⁸ | 2.9 × 10⁷ | 260 | 5.0 |
| III | 9.1 × 10⁸ | 2.9 × 10⁷ | 1.2 | 7.4 |

| | |
|---|---|
| Mean Log-reduction | 6.6 |

TABLE 3B
Test validation

| n1/N1 | n2/N2 | n3/N1 |
|---|---|---|
| n1: 9.5 × 10⁸ CFU/mL | n2: 9.9 × 10⁸ CFU/mL | n3: 1.1 × 10⁹ CFU/mL |
| Requirement | Requirement | Requirement |
| n1 > 0.5 N1 | n2 > 0.5 N2 | n3 > 0.5 N1 |
| 0.5N1 = 5.0 × 10⁸ CFU/mL | 0.5 N2 = 4.7 × 10⁸ CFU/mL | 0.5N3 = 5.0 × 10⁸ CFU/mL |
| Approved | Approved | Approved |

From the Tables 3A and 3B it is evident that a foam process according to the invention delivering 600 ppm Chlorine dioxide accomplishes mean log reduction of >5 with 10 minutes contact time.

As a comparison an experiment performed with the foaming agent without any disinfection composition resulted in mean log reduction of <0.94. In conclusion, Example 3 demonstrates the efficacy of invented methods and products to perform disinfection of space and objects therein. By adjusting contact time and concentrations within what has been defined in this description, the method will be useful in a range of applications.

1. A method of performing a sanitary procedure in a defined space comprising:
introducing to said space a foam comprising a foaming agent and a gas;
adjunctively to introducing the foam, introducing to said space a disinfectant composition comprising an effective amount of chlorine dioxide; and
admitting foam to sufficiently fill said space, thereby admitting the chlorine dioxide composition to sufficiently sanitize the space and surfaces of subjects and/or objects present therein, wherein said foam is a high expansion foam comprising bubbles of a diameter of at least 5 mm.

2. (canceled)

3. The method of claim 1, wherein the disinfectant composition is an aqueous acidic solution comprising 100 to 2000 ppm chlorine dioxide and a sanitizing effect supporting surfactant system.

4. The method according to claim 3, comprising combining the foaming agent and the disinfectant composition and forming a disinfectant foam with the gas.

5. The method according to claim 1, performed in a space assigned for animals subjected to animal husbandry containing animals residing in the space.

6. The method according to claim 5, comprising introducing a first foam with a gas comprising a muscle relaxant without inducing unconsciousness of animals in the space;

7. The method of claim 6, comprising admitting the disinfectant foam to expel the first foam by introducing the disinfectant foam below the first foam.

8. The method according to claim 6, comprising collecting the expelled first foam and extracting dissolved gaseous muscle relaxant.

9. The method according to claim 8, wherein the muscle relaxant is selected from at least one of NO, N₂O and diethyl ether.

10. The method of claim 4, applied on animals infected by one or more pathogens; comprising
introducing to said space a foam comprising a foaming agent and a gas capable of stunning the animals;
adjunctively to introducing the foam, introducing to said space a disinfectant composition comprising chlorine dioxide; and
admitting the foam to stun the animals and to support the disinfectant composition to effectively eliminate pathogens.

11. The method according to claim 1, performed as pest control procedure, comprising:
introducing to the space a foam comprising a foaming agent and a gas with stunning capacity;
adjunctively to introducing the foam, introducing to said space a disinfectant and/or sanitizer composition comprising chlorine dioxide; and
admitting the foam to exert its stunning capacity and to support the disinfectant/sanitizer composition to disinfect the space.

12. The method of any one of claim 1, wherein the gas comprises of at least 95% nitrogen, preferably 98% nitrogen and more preferably 100% nitrogen.

13. The method according to claim 1, comprising introducing a foam comprising a foaming agent and air.

14. The method according to claim 1, for eliminating odors and associated microorganisms in defined spaces, comprising:
introducing the foam to the space;
introducing adjunctively to the foam, a composition comprising an effective amount of chlorine dioxide; and
admitting the foam to sufficiently fill space, so the chlorine dioxide sufficiently can sanitize the space and surfaces, or objects present therein.

15. The method according to claim 1, performed to disinfect non-living animals.

16. The method according to claim 1, comprising simultaneously introducing the foam and the composition of chlorine dioxide to the closed space.

17. A disinfectant product, suitable for claim 1, comprising a foaming agent and an aqueous disinfectant composition comprising chlorine dioxide and an effect supporting surfactant system.

18. The product of claim 17, wherein the foaming agent is an aqueous solution comprising compounds selected from the one or more in the group of a glycol ether solvent; one or more ethoxylated sodium alkyl ether sulfates; and one or more fatty alcohols with saturated carbon chains.

19. The product according to claim 17, wherein the disinfectant and/or sanitizing composition has a pH of 1 to 5.5 and comprises 50 to 2000 ppm chlorine dioxide, and wherein the supporting surfactant system comprises at least one cationic surfactant.

20. The product according to claim 19, wherein the disinfectant composition has an effect supporting surfactant system comprising two or more amine oxides, preferably with different carbon chain lengths, more preferably the amine oxide comprises one amine oxides with 8 carbon atoms and one amine oxide with 12 carbon atoms.

21. The product according to claim 17, comprising the foaming agent and disinfectant composition together in an aqueous solution.

22. The product according to claim 21, comprising 1-10% (volume) of the foaming agent; from 1 to 10% (volume) disinfectant and/or sanitizing composition and water.

23. The product according to claim 17, comprising the foaming agent and the disinfectant composition as parts of kit.
